(19) United States
(12) Patent Application Publication
(10) Pub. No.: US 2014/0364238 A1
(43) Pub. Date: Dec. 11, 2014

(54) DYNAMICALLY GENERATED IN-GAME OBJECTIVES

(71) Applicant: Kabam, Inc., San Francisco, CA (US)

(72) Inventors: James KOH, Mountain View, CA (US); Kellen Chirstopher SMALLEY, Pleasanton, CA (US)

(21) Appl. No.: 13/913,079

(22) Filed: Jun. 7, 2013

(51) Int. Cl. A63F 13/12

(52) U.S. Cl. CPC A63F 13/12
USPC 463/42

(57) ABSTRACT

This disclosure relates to a system and methodology for dynamically generating and implementing game objectives for in-game implementation such that users may attempt to meet these objectives to obtain one or more rewards. In some embodiments, game objectives are determined stochastically or pseudo-stochastically using a variety of components that are combined to create an overall game objective.

### FIELD OF THE DISCLOSURE

This disclosure relates to a system and method for dynamically and randomly generating game objectives within an online game.

### BACKGROUND

Game objectives, including, for example, quests within games are known. In some quests, a reward provided to the user at the end of the quest is determined at completion, and is determined stochastically. These kinds of rewards are commonly referred to as “drops”.

In online games, users may tire of repeating the same quests or other game objectives to obtain the stochastic rewards at completion. This mechanic is typically a part of “grinding” within a game, and can turn players away from a game.

### SUMMARY OF THE DISCLOSURE

One aspect of the disclosure relates to a system for dynamically generating game objectives so that they vary over time and make game play more interesting for players. In some embodiments, game objectives are determined stochastically or pseudo-stochastically using a variety of components that are combined to create an overall game objective. The stochastically generated game objectives may be presented to users to induce the users to participate in the game objectives. The game objectives may be generated on a per-user level, so that individual users are presented with game objectives that have been generated stochastically for them individually.

In exemplary implementations, dynamically generating game objectives for use in connection with game play may be performed by processors executing computer program modules. In some implementations, the system may include one or more servers. The server(s) may be configured to communicate with one or more client computing platforms according to a client/server architecture. The users may access the system via the client computing platforms, for instance, to engage in one or more games.

The server(s) may be configured to execute one or more computer program modules to provide one or more games to users (or players). The computer program modules may include one or more of a game module, a game objective determination module, a reward determination module and/or other modules. It is noted that the client computing platforms may include one or more computer program modules that are the same as or similar to the computer program modules of the server(s) to facilitate individualized content made available to the users of online games.

The game module may be configured to execute an instance of the online game to facilitate presentation of the online game to the users. The game module may be configured to implement in-game actions in the instance of the online game in response to action requests for the in-game actions from the users, wherein the users include a first user.

The game objective determination module may be configured to provide a plurality of game objective components along with associated ranges and possible values for each game objective component. These game objective components along with their associated ranges and possible values are combined by the game objective determination module to generate one or more complete game objectives designed to challenge a user. The game objective determination module may be initiated with a set of game objective components. In some implementations additional game objective components may be added over time.

In some implementations, game objective components such as task type, task amounts, time for completion of game objective and other categories of game objective components may be available for use in generating complete game objectives.

The game objective determination module may be configured to determine one or more game objectives using the available game objective components as described above. The game objective determination module is configured to randomly and/or pseudo-randomly generate game objectives which are implemented by the game module for specific users as these users interact with the game. As a result of this random and/or pseudo-random generation of game objectives using multiple game objective components, a large number of game objectives can be presented to a user and thus enhance prospective usage and continued usage of the online game.

Multiple game objectives may be presented to the user at the same time and/or, in other implementations, game objectives can be presented to the user serially, possibly with later game objectives fully or to some extent dependent upon characteristics of one or more previous game objectives either successfully completed by the user or failed by the user.

In certain implementations, game objectives are communicated to the user and in others they are not. In certain implementations, where game objectives are communicated to the user, they may be communicated to the user in-game and/or through external channels such as via text message, push mobile application notification, email and other communication channels. In implementations, communication of the applicable generated game objectives can be made at the time that the game objective(s) are determined or, alternatively, they may be communicated to the user at some later time.

In some implementations, a reward determination module may be included and configured to generate rewards that are associated with game objectives such that the user receives the reward only if the user completes the game objective(s) as required.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural references unless the context clearly dictates otherwise.

### BRIEF DESCRIPTION OF THE DRAWINGS

FIG. 1 illustrates a system for dynamically generating in-game user game objectives, in accordance with one or more implementations.

FIG. 2 illustrates a method for dynamically generating in-game user game objectives, in accordance with one or more implementations.

### DETAILED DESCRIPTION

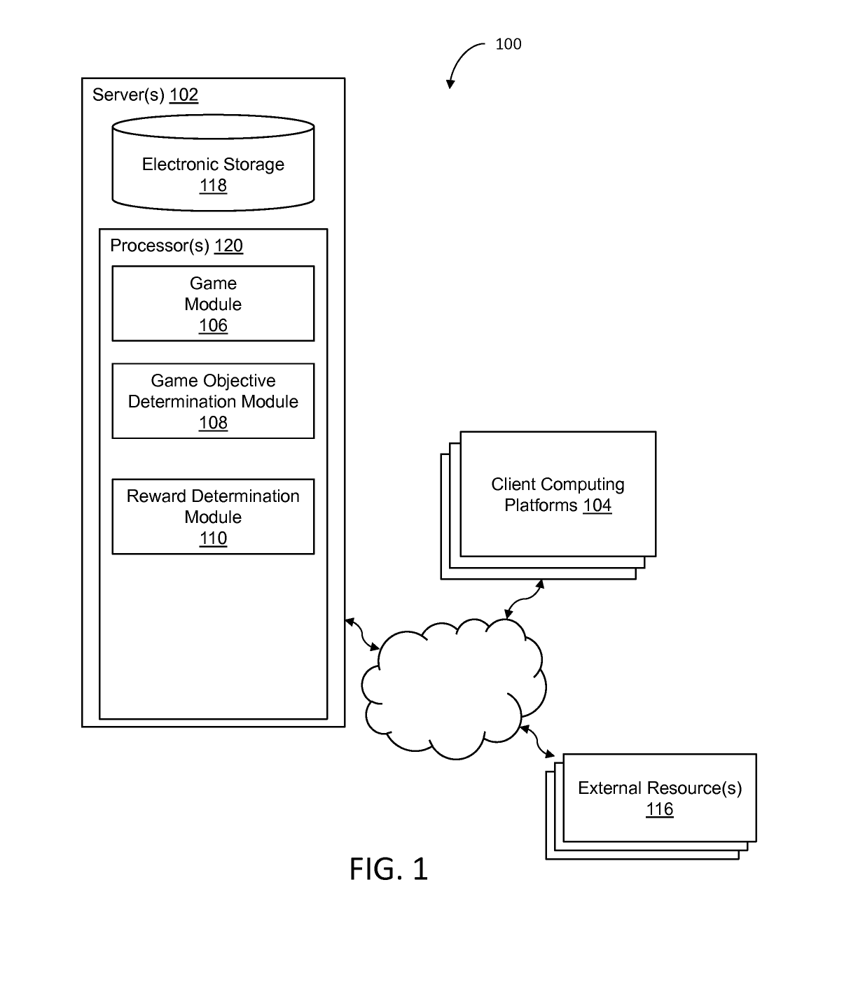

FIG. 1 illustrates a system 100 configured to provide a virtual space. System 100 is only one example of a suitable computing environment and is not intended to suggest any limitation as to the scope of use or functionality of the features described herein. Providing the virtual space may include hosting the virtual space over a network.

In this disclosure, game objectives are generated and implemented in online games in connection with user play. Accordingly, embodiments may be configured for various game objective components and related targets for those components to be combined to create a large number or potential random and pseudo-random overall game objectives. It is also possible for a single game objective component along with a single target to be used for a complete game objective.

Embodiments may be configured such that game objective components are selected from various available classes of components. For example, a game objective component might include a task type such as a requirement that the user train troops to some objective measure, kill specific game characters, kill a specific number of game characters, obtain one or more specific resources, visit a specific area within a virtual world, and others. In various embodiments, one or more of these game objective components are assigned target values or target ranges that the user must meet to achieve the overall game objective. For example, overall game objective satisfaction may require meeting all targets for each of the game objective components or it may require a specific minimum number of game objective components to be satisfied as a condition of overall game objective completion. Other, more complex structures are also possible such as with an “and”/“or” type of expression. For example, if one of the game objective components (component “A”) is achieved, then it may be required to satisfy one set of other game objective components, whereas if component “A” is not achieved, then a different set of other game objective components may be required in order to achieve the overall game objective. As such, the individual game objective components required for successful attainment of the overall game objective can be customized such that an almost unlimited set of game objectives can be generated and implemented.

In addition, the determination of one or more of the game objective components may be influenced by what is determined for one or more of the other game objective components. For example, a different task type may have different target task amount ranges from which a value is stochastically selected.

According to some embodiments, one or more rewards may be associated with each of the overall game objectives. The rewards tied to the objectives may be fixed or they may be randomly or pseudo-randomly generated.

In some implementations, system 100 may include one or more servers 102. The server 102 may be configured to communicate with one or more client computing platforms 104 according to a client/server architecture. The users may access system 100 and/or the virtual space via client computing platforms 104, for instance, to engage in one or more games.

The server(s) 102 may be configured to execute one or more computer program modules. The computer program modules may include one or more of a game module 106, a game objective determination module 108, a reward determination module 110, and/or other modules. As noted, the client computing platform(s) 104 may include one or more computer program modules that are the same as or similar to the computer program modules of the server(s) 102 to facilitate in-game actions.

The game module 106 may be configured to execute an instance of a game to facilitate presentation of the game to users. The game module 106 may be configured to implement in-game actions in the instance of the game, in response to action requests for the in-game actions by the users.

The game may be provided via a virtual space, and may include a plurality of resource types and/or maps. An instance of the virtual space may be executed by computer modules to determine views of the virtual space. The views may then be communicated (e.g., via streaming, via object/position data, and/or other information) from server(s) 102 and/or sources to client computing platforms 104 for presentation to users. The view determined and transmitted to a given client computing platform 104 may correspond to a location in the virtual space (e.g., the location from which the view is taken, the location the view depicts, and/or other locations), a zoom ratio, a dimensionality of objects, a point-of-view, and/or view parameters. One or more of the view parameters may be selectable by the user.

The instance of the virtual space may comprise a simulated space that is accessible by users via clients (e.g., client computing platform(s) 104) that present the views of the virtual space to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial section of the space. In some instances, the topography may describe a volume with one or more bodies positioned therein (e.g., a simulation of gravity-deprived space with one or more celestial bodies positioned therein). The instance executed by the computer modules may be synchronous, asynchronous, and/or semi-synchronous.

The above description of the manner in which views of the virtual space are provided is not intended to be limiting. The virtual space may be expressed in a more limited, or more rich, manner. For example, views determined for the virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual space are contemplated.

Within the instance(s) of the virtual space, users may control characters, objects, simulated physical phenomena (e.g., wind, rain, earthquakes, and/or other phenomena), and/or other elements within the virtual space to interact with the virtual space and/or each other. The user characters may include avatars. As used herein, the term “user character” may refer to an object (or group of objects) present in the virtual space that corresponds to an individual user. The user character may be controlled by the user with which it is associated.

User-controlled element(s) may move through and interact with the virtual space (e.g., non-user characters in the virtual space, other objects in the virtual space). The user-controlled elements controlled by and/or associated with a given user may be created and/or customized by the given user. The user may have an “inventory” of virtual goods and/or currency (e.g., resources of the plurality of resource types) that the user can use (e.g., by manipulation of a user character or other user-controlled element, and/or other items) to perform in-game actions within the virtual space.

The users may participate in the instance of the virtual space by controlling one or more of the available user-controlled elements in the virtual space. Control may be exercised through control inputs and/or commands input by the users through client computing platforms 104. The users may interact with each other through communications exchanged within the virtual space. Such communications may include one or more of textual chat, instant messages, private messages, voice communications, and/or other communications. Communications may be received and entered by the users via their respective client computing platforms 104. Communications may be routed to and from the appropriate users through server(s) 102. In implementations, the game module 106 may also be configured to implement the game objectives generated for in-game implementation as described herein.

The game objective determination module 108 may be configured to generate game objectives as described above. In implementations, one or more game objective components along with target value or target value ranges are selected to determine an overall game objective which can be implemented in connection with game play. If the game objective is satisfied by the user, one or more rewards may be offered.

In some embodiments, the game objective determination module 108 is configured so that once one game objective expires (e.g. because a real world amount of time to complete the objective has elapsed) or is completed, another objective may be determined and implemented. In some embodiments, game objectives may be communicated to users within the game and/or through external notification channels when the are generated (e.g. text message, push mobile application notification, email, etc.).

Reward determination module 110 may be configured to associate one or more rewards with each game objective generated by game objective determination module 108. These rewards may be randomly or pseudo-randomly generated and matched with various game objectives.

In some implementations, server(s) 102, client computing platforms 104, and/or external resources 116 may be operatively linked via one or more electronic communication links. For example, such electronic communication links may be established, at least in part, via a network such as the Internet and/or other networks. The network may be a wired or wireless network such as the Internet, an intranet, a LAN, a WAN, a cellular network or another type of network. It will be understood that the network may be a combination of multiple different kinds of wired or wireless networks. It will be appreciated that this is not intended to be limiting, and that the scope of this disclosure includes implementations in which server(s) 102, client computing platforms 104, and/or external resources 116 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 116, and/or provide other functionality attributed herein to client computing platforms 104. By way of non-limiting example, the given client computing platform 104 may include one or more of a desktop computer, a laptop computer, a handheld computer, a tablet computing platform, a netbook, a smartphone, a gaming console, and/or other computing platforms.

External resources 116 may include sources of information, hosts and/or providers of virtual environments outside of system 100, external entities participating with system 100, and/or other resources. In some implementations, some or all of the functionality attributed herein to external resources 116 may be provided by resources included in system 100.

Server 102 may include electronic storage 118, one or more processors 120, and/or other components. Server 102 may include communication lines, or ports to enable the exchange of information with a network and/or other computing platforms. Illustration of server 102 in FIG. 1 is not intended to be limiting. Server 102 may include a plurality of hardware, software, and/or firmware components operating together to provide the functionality attributed herein to server 102. For example, server 102 may be implemented by a cloud of computing platforms operating together as server 102.

Electronic storage 118 may comprise non-transitory storage media that electronically stores information. The electronic storage media of electronic storage 118 may include one or both of system storage that is provided integrally (i.e., substantially non-removable) with server 102 and/or removable storage that is removably connectable to server 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources). Electronic storage 118 may store software algorithms, information determined by processor 120, information received from server 102, information received from client computing platforms 104, and/or other information that enables server 102 to function as described herein.

Processor(s) 120 is configured to provide information processing capabilities in server 102. As such, processor 120 may include one or more of a digital processor, an analog processor, a digital circuit designed to process information, an analog circuit designed to process information, a state machine, and/or other mechanisms for electronically processing information. Although processor 120 is shown in FIG. 1 as a single entity, this is for illustrative purposes only. In some implementations, processor 120 may include a plurality of processing units. These processing units may be physically located within the same device, or processor 120 may represent processing functionality of a plurality of devices operating in coordination. The processor 120 may be configured to execute modules 106, 108, and 110. Processor 120 may be configured to execute modules 106, 108, and 110 by software; hardware; firmware; some combination of software, hardware, and/or firmware; and/or other mechanisms for configuring processing capabilities on processor 120. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 106, 108, and 110 are illustrated in FIG. 1 as being implemented within a single processing unit, in implementations in which processor 120 includes multiple processing units, one or more of modules 106, 108, and 110 may be implemented remotely from the other modules. The description of the functionality provided by the different modules 106, 108, and 110 described above is for illustrative purposes, and is not intended to be limiting, as any of modules 106, 108, and 110 may provide more or less functionality than is described. For example, one or more of modules 106, 108, and 110 may be eliminated, and some or all of its functionality may be provided by other ones of modules 106, 108, and 110. As another example, processor 120 may be configured to execute one or more additional modules that may perform some or all of the functionality attributed below to one of modules 106, 108, and 110.

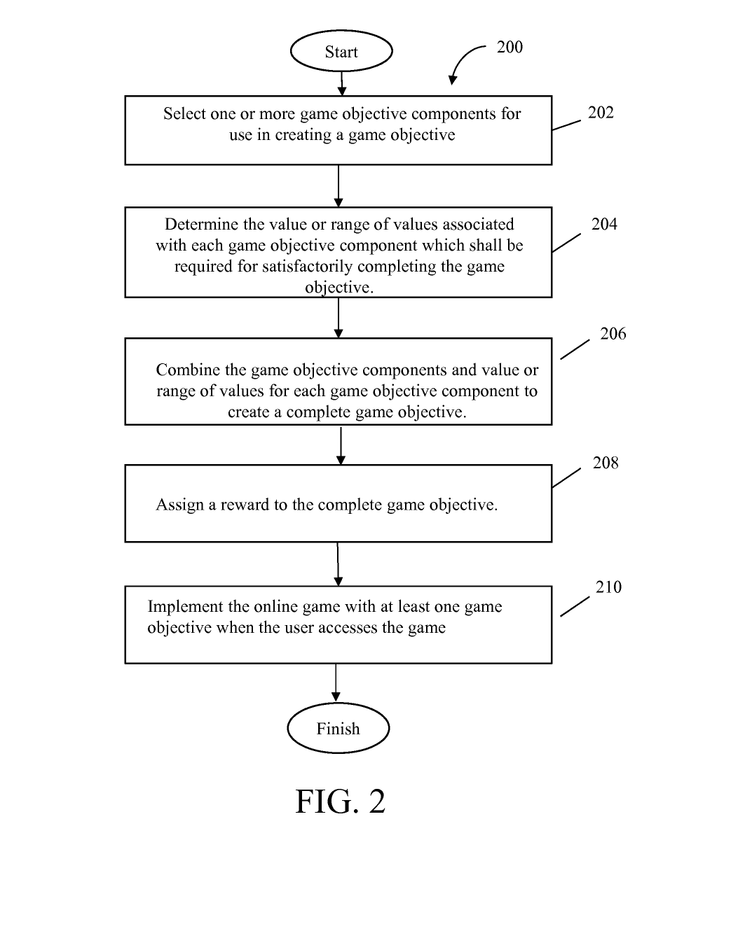

FIG. 2 illustrates a method for dynamically generating game objectives for use in connection with game play, in accordance with one or more implementations. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At an operation 202, one or more game objective components are selected for use in creating a game objective. Game objective components may include, for example, task types as well as target values or ranges of values required to achieve the specific game objective component. Operation 202 may be performed by a game objective determination module that is the same as or similar to game objective determination module 108, in accordance with one or more implementations.

At an operation 204, a value or range of values required for satisfactorily completing a game objective component is determined for each game objective component. Operation 204 may be performed by a game objective determination module that is the same as or similar to game objective determination module 108, in accordance with one or more implementations.

At an operation 206, all of the selected game objective components and their associated target values and/or target value ranges are combined to create a complete game objective. This operation may, in some embodiments, also include the determination of the specific arrangement of game objective components required for satisfactorily completing the overall game objective. For example, there may be three game objective components each with their own target value. In this example, a user meeting at least two of the three game objective components may be deemed to have met the overall game objective.

As noted above, it is also possible that successful completion of certain game objective components may trigger different target values or ranges to be associated with other game objective components comprising the overall game objective. Other relationships between and among the game objective components is also possible. As such, a practically unlimited number of different game objectives can be generated and used. Operation 206 may be performed by a game objective determination module that is the same as or similar to game objective determination module 108, in accordance with one or more implementations.

At operation 208, at least one reward is assigned to each game objective. These rewards can be any of a variety of objects, benefits or other aspects tied to future game play by the user and/or rewards that are unrelated to gameplay. Operation 208 may be performed by a reward determination module that is the same as or similar to reward determination module 110, in accordance with one or more implementations.

At an operation 210, an instance of an online game may be executed to facilitate presentation of the game to users. The game, as implemented, may include one or more game objectives associated with user play based on the user playing the game. While the game is being played or before or after, the game objectives and possibly the game objective components may be communicated to a user. This may be accomplished in various manner such as by text, email, push mobile notification and others. Operation 210 may be performed by a game module that is the same as or similar to game module 106, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. An online gaming system allowing for customizable interaction, the system comprising:
one or more processors configured to execute computer program modules, the computer program modules comprising:
a game objective determination module configured to generate at least one game objective tied to at least one reward;
a reward determination module configured to generate said at least one reward to be provided to a first user in the event said first user successfully completes said at least one game objective; and
a game module configured to execute an instance of an online game, and to implement the instance of the online game to facilitate participation of users in the online game, the game module being further configured to implement said at least one game objective tied to said at least one reward based upon successful completion of the game objective by said first user.

2. The online gaming system of claim 1 wherein the game objective determination module is configured such that generating a game objective comprises automatically selecting at least one component for the game objective, wherein the at least one component includes one or more of task type, task amount or allotted time for task completion.

3. The online gaming system of claim 2 wherein the game objective determination module is configured such that the at least one automatically selected component includes a task type, and further such that automatically selecting the task type comprises selecting from a set of potential task types, the set of potential task types comprising one or more of a train troops task, a kill wilds task, a defeat other players task or an obtain resource task.

4. The online gaming system of claim 2 wherein the game objective determination module is configured such that the at least one automatically selected component includes an allotted time for task completion that specifies an amount of real world time permitted to successfully achieve said task completion.

5. The online gaming system of claim 1 wherein the game objective determination module is configured such that automatically selecting said at least one game objective comprises making a stochastic selection.

6. The online gaming system of claim 1 wherein the game objective determination module is configured such that automatically selecting said at least one game objective comprises making a pseudo-stochastic selection.

7. The online gaming system of claim 1 wherein generated game objectives are communicated to users.

8. The online gaming system of claim 7 wherein said generated game objectives are communicated to users through one or more of text message, push mobile application notification or email.

9. The online gaming system of claim 2 wherein the game objective selection module is configured such that automatically selecting at least one component for said game objective automatically and individually selecting a plurality of said components and wherein the selection associated with at least one of said components is dependent upon the selection of another of said at least one components.

10. A computer-implemented method for in-game customization of online games, the method being implemented in a computer system that includes one or more physical processors and storage media storing machine-readable instructions, the method comprising:
selecting one or more game objective components to be used in the determination of at least one game objective;
obtaining information associated with possible values for each of said selected game objective components;
stochastically determining one or more of said game objectives based upon said selected game objective components and said information associated with possible values for each of said selected game objective components; and
implementing an online game with said one or more game objectives when said online game is accessed by a user.

11. The method of claim 10 wherein said one or more game objective components comprises at least one or more of task type, task amount or allotted time for task completion.

12. The method of claim 11 wherein the game objective components includes a task type, and further such that task type component comprises at least one of a train troops task, a kill wilds task, a defeat other players task or an obtain resource task.

13. The method of claim 11 wherein the game objective components includes a task type, and further said allotted time for task completion component specifies an amount of real world time permitted to successfully achieve said task completion.

14. The method of claim 11 wherein said one or more game objectives is determined stochastically.

15. The method of claim 10 wherein said one or more game objectives is determined pseudo-stochastically.

16. The method of claim 10 further comprising the step of communicating game objectives to users.

17. The method of claim 16 wherein said game objectives are communicated to users through one or more of text message, push mobile application notification or email.

18. The method of claim 10 wherein said game objectives are determined based upon a plurality of said game objective components and wherein the selection associated with at least one of said game objective components is dependent upon the selection of another of said at least one game objective components.
